(19) United States
(12) Patent Application Publication
(10) Pub. No.: US 2018/0033074 A1
(43) Pub. Date: Feb. 1, 2018

(54) SYSTEM, METHOD, AND RECORDING MEDIUM FOR RECIPE AND SHOPPING LIST RECOMMENDATION

(71) Applicant: International Business Machines Corporation, Armonk, NY (US)

(72) Inventors: Keith William Grueneberg, Stewart Manor, NY (US); Bong Jun Ko, Harrington Park, NJ (US); Christian Makaya, Yorktown Heights, NY (US); Mikhil Nandkishore MasIi, Elmsford, NY (US); Jorge Jose Ortiz, Rego Park, NY (US); Swati Rallapalli, Ossining, NY (US); Theodoros Salonidis, Boston, MA (US); Rahul Urgaonkar, Yorktown Heights, NY (US); Dinesh C. Verma, New Castle, NY (US); Xiping Wang, Scarsdale, NY (US)

(21) Appl. No.: 15/224,568

(22) Filed: Jul. 31, 2016

(51) Int. Cl. G06Q 30/06

(52) U.S. Cl. CPC G06Q 30/0633; G06Q 50/01

(57) ABSTRACT

A recipe recommendation method, system, and non-transitory computer readable medium, include inferring a fine-grained user food profile from user data, recommending a recipe for the user based on a fitness score associated with a user-recipe pairing according to the fine-grained user food profile and recipe data, extracting ingredients from the recommended recipe, and creating a shopping list from the extracted ingredients.

### BACKGROUND

The present invention relates generally to a recipe recommendation method, and more particularly, but not by way of limitation, to a system, method, and recording medium for understanding fine-grained user behavior and preferences to provide better cooking or shopping planners.

People search and determine what to eat each week, what is feasible to make and which of the options is best for their tastes given the ingredients, tools, skill level, etc.

Conventional recipe recommendation techniques consider a very broad level of parameters such as a level of skill, preferred foods, allergies, and diet types to recommend a type of recipe to cook. However, the conventional techniques do not consider fine-grained preferences to compute a fitness score to recommend a recipe (e.g., based on a time of day, cooking skill for a particular class of recipes, availability of ingredients, etc.).

### SUMMARY

That is, the inventors have identified a technical problem in the conventional techniques that the conventional techniques do not consider a fine-grained association of user preferences of food to recommend recipes.

Thus, the inventors have realized a technical solution to the technical problem by understanding and updating fine-grained user food preferences either explicitly input or inferred to recommend dishes and map the dishes to the best suited recipes for the user. Also, the inventors have realized the technical solution that, based on the ingredients and cookery skills required for each of these recipes, calculating a fitness-score to select the best recipe for the user for each dish in the list. Therefore, the technical solutions provide significantly more than the conventional techniques that require user intervention and thinking because the technical solutions allow the users to not have to consider dishes they want to cook but instead automatically recommends dishes and then recipes can be automatically inferred and shopping lists can be generated.

In an exemplary embodiment, the present invention can provide a recipe recommendation method, the method including inferring a fine-grained user food profile from user data, recommending a recipe for the user based on a fitness score associated with a user-recipe pairing according to the fine-grained user food profile and recipe data, extracting ingredients from the recommended recipe, and creating a shopping list from the extracted ingredients.

Further, in another exemplary embodiment, the present invention can provide a non-transitory computer-readable recording medium recording a recipe recommendation program, the program causing a computer to perform: inferring a fine-grained user food profile from user data, recommending a recipe for the user based on a fitness score associated with a user-recipe pairing according to the fine-grained user food profile and recipe data, extracting ingredients from the recommended recipe, and creating a shopping list from the extracted ingredients.

Even further, in another exemplary embodiment, the present invention can provide a recipe recommendation system, said system including a processor, and a memory, the memory storing instructions to cause the processor to: infer a fine-grained user food profile from user data, recommend a recipe for the user based on a fitness score associated with a user-recipe pairing according to the fine-grained user food profile and recipe data, extract ingredients from the recommended recipe, and create a shopping list from the extracted ingredients.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a high-level flow chart for a recipe recommendation method 100.

FIG. 2 depicts a cloud computing node according to an embodiment of the present invention.

FIG. 3 depicts a cloud computing environment according to another embodiment of the present invention.

FIG. 4 depicts abstraction model layers according to an embodiment of the present invention.

### DETAILED DESCRIPTION

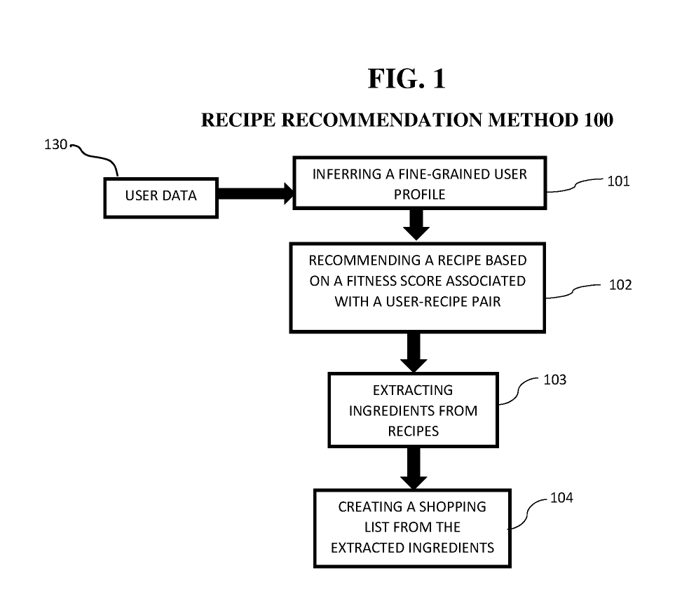

The invention will now be described with reference to FIGS. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

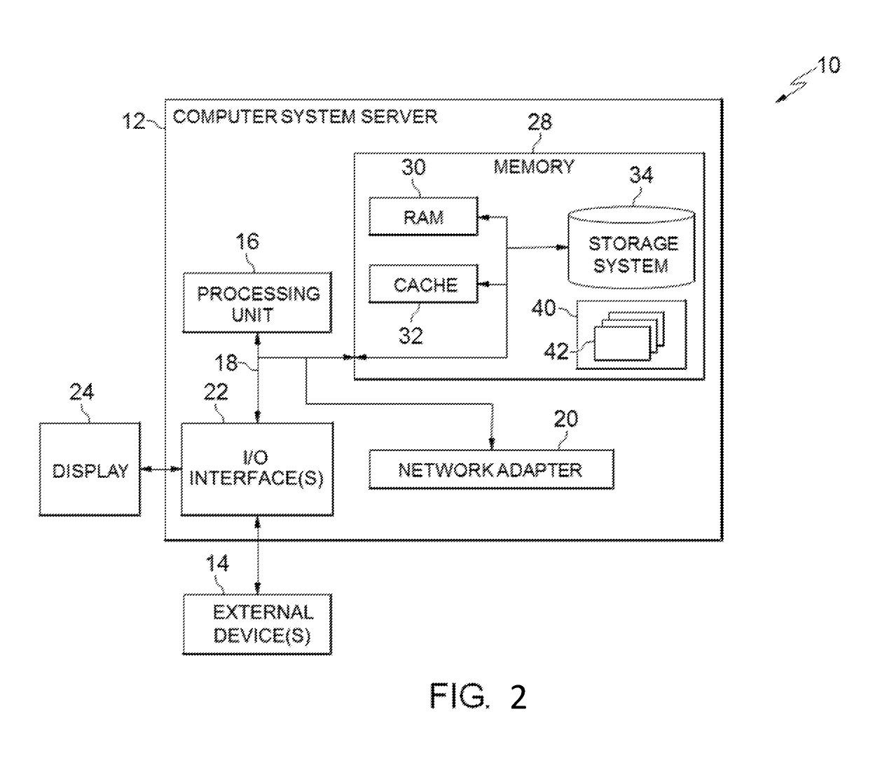

With reference now to FIG. 1, the recipe recommendation method 100 includes various steps to infer a fine-grained user food and cooking profile and recommend best suited recipes based on the calculation of a fitness-score according to the profile and then extract the ingredients of the recipes to create a shopping list. As shown in at least FIG. 2, one or more computers of a computer system 12 can include a memory 28 having instructions stored in a storage system to perform the steps of FIG. 1.

With the use of these various steps and instructions, the recipe recommendation method 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

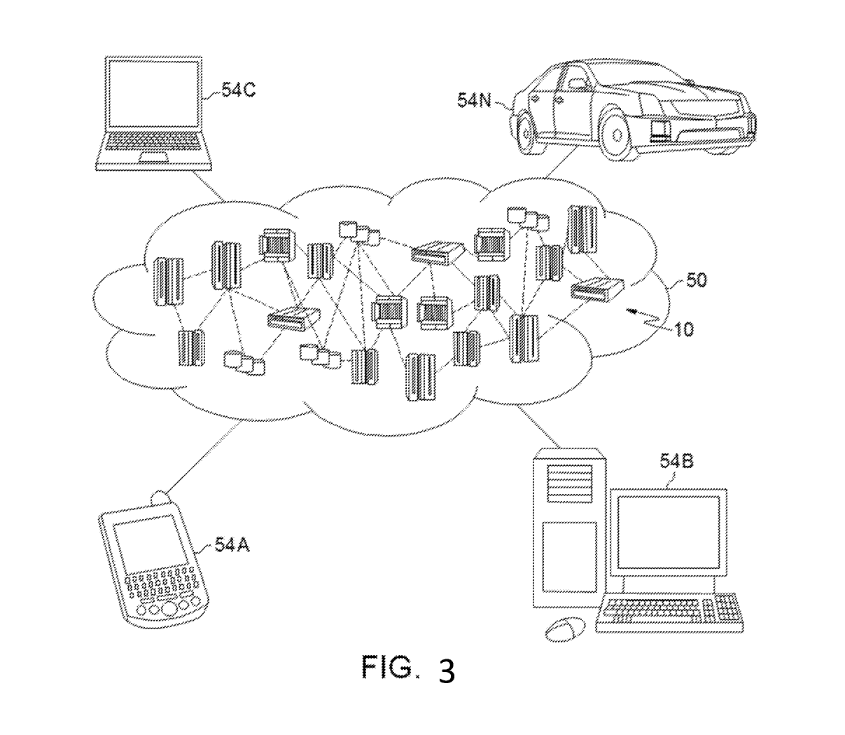

Although as shown in FIGS. 2-4 and as described later, the computer system/server 12 is exemplarily shown as one or more cloud computing nodes 10 of the cloud environment 50 as a general-purpose computing circuit which may execute in a layer the recipe recommendation system method (FIG. 3), it is noted that the present invention can be implemented outside of the cloud environment.

Step 101 infers a fine-grained user profile based on user data 130. The user data used to infer the fine-grained user profile can include, for example, user likes, dislikes and diet preferences, etc. That is, the user can input parameters (or the parameters can be extracted) to indicate, for example, if the user is a vegetarian, a vegan, a pescetarian, etc., allergies of the user, favorite cuisines, cuisines disliked or disfavored, seasonal favorite foods (e.g., baked goods in winter and grilled foods in summer), past ratings and review of recipes to determine a likeness of the recipe, demographic information, any unstructured text message provided such as “I love to eat pancakes for breakfast only with maple syrup during weekends”, or the like. Also, the user data 130 comprises recipes searched for and browsed including the time spent looking at each recipe to potentially infer a likeness of the recipe. Further, the user data 130 used to infer the fine-grained user profile can be extracted from pictures the user has posted or browsed such as extracting particular types of foods in pictures the user has posted or from social media “likes” of the user of dishes (e.g., the user “pinning” a food item on Pinterest®.

The user diet preferences can be based on past purchases, responses and facial expressions of users while eating different items, explicit user inputs, inferred from user purchases and cooking history, root cause analysis to figure out why users liked/disliked recipes, or the like.

The fine-grained user profile can be updated based on a time-recipe correlation by learning user preferences such as the user not selecting recommended recipes (as described later) at certain times of day, year, etc. The fine-grained user profile can also be updated based on an ingredient-recipe correlation by, for example, learning when a user did not like a recipe when he bought a type of ingredient but liked it when he bought a different type of ingredient since a store knows what items the user bought such that Step 101 can correlate the purchases with items made during the week. Additionally, the fine-grained user profile can be inferred by a recipe-to-recipe correlation such as a user liking two recipes paired together but not individually (e.g., garlic bread and pasta but not garlic bread alone). Further, the user likes, dislikes, and diet preferences can consider a root cause analysis to infer the fine-grained user profile by finding out why the user did not like an item. The reason could be subtle such as the user finds certain kinds of tomatoes too sour. Step 101 can apply techniques like latent semantic indexing, compound term processing, or bag of words model with the ingredients of the recipe with the user data 130 to infer the fine-grained user profile.

The user data 130 can also include ingredients present at the user's home (or usually present in the user's home) based on a past purchase history of user, opportunistically take pictures of a user's pantry with a user device, any partial shopping list prepared by user, or the like.

The user data 130 further comprises cookery skills of the user in making a particular class of dishes based on posts of the user on cookery forums, past dishes prepared by the user, explicit user input (e.g., a level of the skill as determined by the user), or the like.

The user data 130 comprises tools available at the user's home in order to make the recipes. For example, if a user has a rolling pin for pizza, then a likely recipe begins from making a pizza base. Otherwise it may begin from a buying pizza roller at a store or the tools can be determined from past purchase history, user input, opportunistic pictures, etc.

The user data 130 further may comprise data from friends of the user and be used for collaborative filtering of recipes in that, friends may like similar dishes in which the friends can be discovered either via information indicated by the user or a login with Twitter®, Facebook®, etc.

That is, Step 101 infers the fine-grained user profile based on user data 130 comprising user likes, dislikes, and diet preferences, ingredients present at the user's home, cookery skills of the user in making a particular class of dishes, tools available at the user's home, friends of the user, or the like. The descriptions of the various types of user data 130 of the present invention have been presented for purposes of illustration, but are not intended to be exhaustive or limited to the embodiments disclosed.

Step 102 recommends a recipe for the user based on a fitness score associated with a user-to-recipe pair. That is, the fitness score represents a score of how likely the recipe will fit the needs of the user. The fitness score takes into account each of the fine-grained preferences of the user in the fine-grained user profile for each of the recipes and each particular class of recipe (e.g., each fine-grained part of the user profile is linked and checked with each particular class of recipe).

Step 102 recommends the recipe based on a computation of the fitness score by estimating a difficulty-of-preparation score, fondness score (based on how much user/user's friends like this or similar recipes), ingredient availability score, a difficulty-of-obtaining-ingredients score, an expertise in preparing similar recipes, a time of the day (week/year), day of the week correlation with the recipe for a user, a temperature outside (e.g., not to bake on a hot day), a tool availability score, etc. and weights for the scores by analyzing user reactions to recipe recommendations and based on the fine-grained user profile to determine a score for each of the exemplary factors.

That is, some of the factors are based on a recipe itself, but others are a combination of the recipe and the fine-grained user profile such as determining ingredients available to the user in the fine-grained user profile and scoring a recipe based on the available ingredients (e.g., if a recipe requires flour and the user does not have flour, the recipe will not receive as high of a score as if the user had flour).

The expertise in preparing similar recipes (e.g., a cooking skill) can be computed based on how good is the user in making similar recipes determined from the fine-grained user profile such as if the user is good at making deep dish pizza may not mean the user is good at making Indian style paneer masala pizza. The cooking skill is for each particular class of individual recipe. For example, the fine-grained user profile includes a cooking skill for each type of cuisine and the fitness factor is determined accordingly. That is, the user may be an expert with grilled foods or Cuban cuisine, but a beginner with German foods and this differentiation between skills is factored into the fitness factor.

The difficulty-of-preparation score can be computed by analyzing the steps of the recipes and then weighted against the fine-grained user profile to determine if the user has adequate skill to prepare the recipe.

The ingredient availability score can be computed based on how many ingredients are available in the user's home and will need to be used. Also, some ingredients may spoil if not used quickly in the user's home and recipes using spoiling ingredients can receive a higher fitness score (e.g., a meat spoils quicker than canned good).

The difficulty-of-obtaining-ingredients score is determined based on the ingredient list of the recipe and the associated difficulty it would be to obtain each ingredient if the user does not have the ingredients available according to the fine-grained user profile. For example, a recipe using fresh shark may be scored less for a user living far from an ocean as compared to a recipe using beef if the user is near a cattle farm.

The tool availability score is determined based on the required cooking tools to make the recipe and correlated the required tools with the fine-grained user profile to determine if the user has the tool requires. For example, the purchase history of the user or pictures of the user's kitchen can be used to determine what tools the user has which are part of the fine-grained user profile.

The fondness score can be determined based on collaborative filtering of the fine-grained user profile with the recipes to determine how the user likes the recipe in the past or other similar recipes.

The time of day, week, or year can be used to determine the fitness score based on the recipe being likely to be liked based on the fine-grained user profile at that particular time. For example, a lengthy recipe to prepare may be more liked on a day off of work by the user so they have time to prepare or a baked good may be preferred during the winter so as to not heat the house in the summer with the stove. Similarly, cold or chilled foods may be favored in the summer but not in the winter.

Each of the factors is used to compute a fitness score for the recipe based on the user being likely to select the recipe and Step 102 recommends the recipes with a highest fitness score.

Step 103 extracts each ingredient from the recommended recipe of Step 102. Step 103 can use text processing to map recipes to items including the item and the amount of the item required in the recipe.

Step 104 creates a shopping list for the user from the extracted ingredients. Step 104 also checks the items of the shopping list with the fine-grained user profile to determine if the user is allergic or has any dietary restrictions against the items. Step 104 can substitute items of the shopping list for items to which the user is not allergic (e.g., soy milk for dairy milk).

Also, Step 104 infers the ingredients already present at user's home based on the fine-grained user profile such as the shopping history of the user by analyzing how frequently the user buys an item and when was the last that the user bought the item, by opportunistically taking images on the user's phone or wearable when the person opens the fridge or pantry door and analyze these images to see how much of item is remaining, or the like.

Thus, by the steps of the method 100, the method 100 can infer a fine-grained user profile and recommend the most suitable recipes based on a “fitness-score” for a user-recipe pair. This score is computed based on several other scores such as a recipe-difficulty score, expertise-in-preparing-similar-recipes score, a fondness score based on person's own history and analysis of posts on cookery forums on social network, an ingredient-availability score, a difficulty-of-obtaining-ingredients score, a tool-availability-score, a time-recipe-affinity-score, a weighting of these different parameters that is customized to every user based on how well they like the recommendations, or the like.

Further, a shopping plan from list of dishes can be created based on the recommended recipes while taking into consideration user preferences (e.g., allergies, diet restrictions, etc.) and items available to the user to determine a shopping list for the user. Also, stores can benefit from tracking the items most frequently added to a shopping list to have their inventory compensated for those items.

Exemplary Hardware Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

As shown in FIG. 2, computer system/server 12 in cloud computing node 10 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

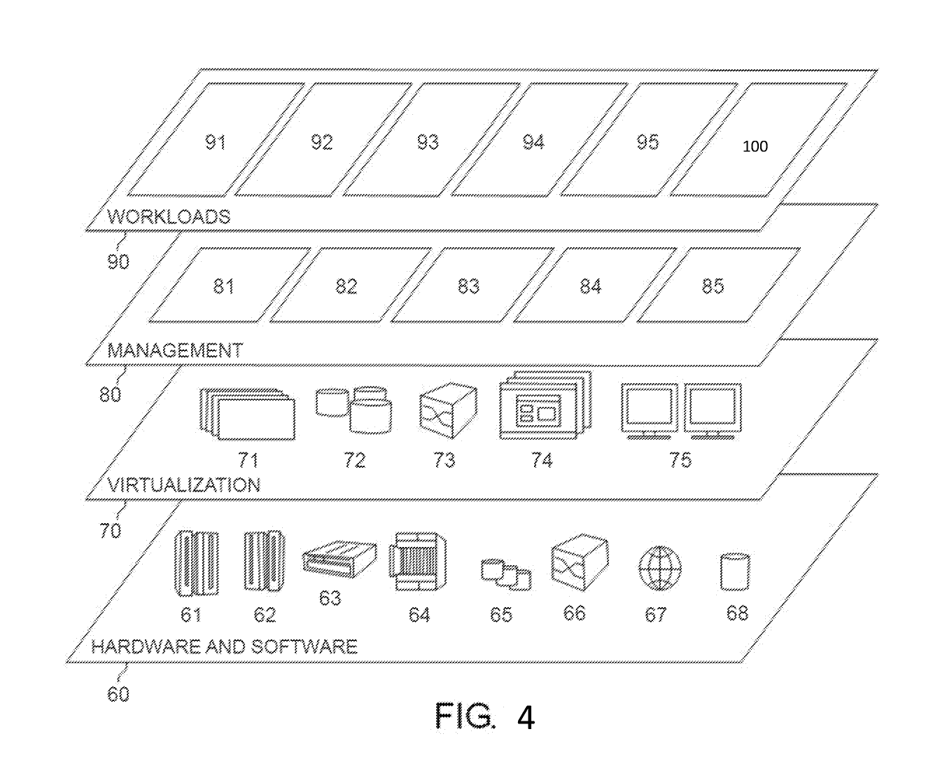

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the recipe recommendation method 100 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A recipe recommendation method, the method comprising:
inferring a fine-grained user food profile from user data;
recommending a recipe for the user based on a fitness score associated with a user-recipe pairing according to the fine-grained user food profile and recipe data;
extracting ingredients from the recommended recipe; and
creating a shopping list from the extracted ingredients.

2. The method of claim 1, wherein the fitness score associated with the user-recipe pairing is computed by estimating:
a difficulty-of-preparation score;
a fondness score;
an ingredient availability score;
a difficulty-of-obtaining-ingredients score;
an expertise score in preparing similar recipes;
a time of a day score, a time of a week score, and a time of a year score correlated with the recipe for a user;
a temperature outside score; and
a tool availability score,
wherein each of the scores is weighted together for the recipe based on the fine-grained user profile to determine the fitness score for the recipe.

3. The method of claim 1, wherein the fitness score associated with the user-recipe pairing is computed by estimating at least one of:
a difficulty-of-preparation score;
a fondness score;
an ingredient availability score;
a difficulty-of-obtaining-ingredients score;
an expertise score in preparing similar recipes;
a time of a day score, a time of a week score, and a time of a year score correlated with the recipe for a user;
a temperature outside score; and
a tool availability score,
wherein the estimated score is weighted for the recipe based on the fine-grained user profile to determine the fitness score for the recipe.

4. The method of claim 1, wherein the user data comprises at least one of:
a user liking a recipe;
the user disliking a recipe;
a diet preference of the user;
ingredients present at the user's home;
a cookery skill of the user in making a particular class of dishes;
a tool available at the user's home; and
friends of the user.

5. The method of claim 1, wherein the creating maps extracted ingredients of the recipe to the fine-grained user profile to substitute ingredients based on the user preferences.

6. The method of claim 1, wherein the creating infers the ingredients already present at the user's home based on the fine-grained user food profile and creates the shopping list omitting the ingredients already present at the user's home.

7. The method of claim 1, wherein the user-recipe pairing comprises a paring of features of the fine-grained user food profile to each particular class of recipe.

8. A non-transitory computer-readable recording medium recording a recipe recommendation program, the program causing a computer to perform:
inferring a fine-grained user food profile from user data;
recommending a recipe for the user based on a fitness score associated with a user-recipe pairing according to the fine-grained user food profile and recipe data;
extracting ingredients from the recommended recipe; and
creating a shopping list from the extracted ingredients.

9. The non-transitory computer-readable medium of claim 8, wherein the fitness score associated with the user-recipe pairing is computed by estimating:
a difficulty-of-preparation score;
a fondness score;
an ingredient availability score;
a difficulty-of-obtaining-ingredients score;
an expertise score in preparing similar recipes;
a time of a day score, a time of a week score, and a time of a year score correlated with the recipe for a user;
a temperature outside score; and
a tool availability score,
wherein each of the scores is weighted together for the recipe based on the fine-grained user profile to determine the fitness score for the recipe.

10. The non-transitory computer-readable medium of claim 8, wherein the fitness score associated with the user-recipe pairing is computed by estimating at least one of:
a difficulty-of-preparation score;
a fondness score;
an ingredient availability score;
a difficulty-of-obtaining-ingredients score;
an expertise score in preparing similar recipes;
a time of a day score, a time of a week score, and a time of a year score correlated with the recipe for a user;
a temperature outside score; and
a tool availability score,
wherein the estimated score is weighted for the recipe based on the fine-grained user profile to determine the fitness score for the recipe.

11. The non-transitory computer-readable medium of claim 8, wherein the user data comprises at least one of:
a user liking a recipe;
the user disliking a recipe;
a diet preference of the user;
ingredients present at the user's home;
a cookery skill of the user in making a particular class of dishes;
a tool available at the user's home; and
friends of the user.

12. The non-transitory computer-readable medium of claim 8, wherein the creating maps extracted ingredients of the recipe to the fine-grained user profile to substitute ingredients based on the user preferences.

13. The non-transitory computer-readable medium of claim 8, wherein the creating infers the ingredients already present at the user's home based the fine-grained user food profile and creates the shopping list omitting the ingredients already present at the user's home.

14. The non-transitory computer-readable medium of claim 8, wherein the user-recipe pairing comprises a paring of features of the fine-grained user food profile to each particular class of recipe.

15. A recipe recommendation system, said system comprising:
a processor; and
a memory, the memory storing instructions to cause the processor to:
infer a fine-grained user food profile from user data;
recommend a recipe for the user based on a fitness score associated with a user-recipe pairing according to the fine-grained user food profile and recipe data;
extract ingredients from the recommended recipe; and
create a shopping list from the extracted ingredients.

16. The system of claim 15, wherein the fitness score associated with the user-recipe pairing is computed by estimating:
a difficulty-of-preparation score;
a fondness score;
an ingredient availability score;
a difficulty-of-obtaining-ingredients score;
an expertise score in preparing similar recipes;
a time of a day score, a time of a week score, and a time of a year score correlated with the recipe for a user;
a temperature outside score; and
a tool availability score,
wherein each of the scores is weighted together for the recipe based on the fine-grained user profile to determine the fitness score for the recipe.

17. The system of claim 15, wherein the fitness score associated with the user-recipe pairing is computed by estimating at least one of:
a difficulty-of-preparation score;
a fondness score;
an ingredient availability score;
a difficulty-of-obtaining-ingredients score;
an expertise score in preparing similar recipes;
a time of a day score, a time of a week score, and a time of a year score correlated with the recipe for a user;
a temperature outside score; and
a tool availability score,
wherein the estimated score is weighted for the recipe based on the fine-grained user profile to determine the fitness score for the recipe.

18. The system of claim 15, wherein the user data comprises at least one of:
a user liking a recipe;
the user disliking a recipe;
a diet preference of the user;
ingredients present at the user's home;
a cookery skill of the user in making a particular class of dishes;
a tool available at the user's home; and
friends of the user.

19. The system of claim 15, wherein the creating maps extracted ingredients of the recipe to the fine-grained user profile to substitute ingredients based on the user preferences.

20. The system of claim 15, wherein the creating infers the ingredients already present at the user's home based the fine-grained user food profile and creates the shopping list omitting the ingredients already present at the user's home.
